(19) United States
(12) Patent Application Publication
(10) Pub. No.: US 2004/0206869 A1
(43) Pub. Date: Oct. 21, 2004

(54) Runner rail clamping holder for fixing runner rails for sliding door systems

(76) Inventor: Hubert Elmer, Innsbruck (AT)

Correspondence Address: COHEN, PONTANI, LIEBERMAN & PAVANE, 551 FIFTH AVENUE, SUITE 1210, NEW YORK, NY, 10176, US

(21) Appl. No.: 10/486,818

(22) PCT Filed: Aug. 16, 2002
(86) PCT No.: PCT/EP02/09160

(30) Foreign Application Priority Data
Aug. 16, 2001 (DE) 101 39 167.6

(51) Int. Cl. E05D 15/00

(52) U.S. Cl. 248/215

(57) ABSTRACT

A single-piece track clamping holder for mounting a track of a sliding door system on a substrate includes a track receiver formed as a single piece and having a track receiving opening profiled to extend around more than half the circumference of a track, the track receiver having a wall bounding the receiving opening, and at least one clamping opening in the side of the wall facing the substrate. A clamping device received in each clamping opening can be acted on so that the holder is non-positively clamped to both the track and the substrate.

The invention concerns an object in accordance with the primary application DE 100 35 956 according to the general concept of claim 1.

Track clamping holders are known from the brochure “Ordering and Design Handbook, DORMA Manet, The Glass Construction System, Imprint 6/98” of the applicant, pp. 3/01 to 3/06. Various systems of track mounting are used there. Either the tracks must be provided with undesirable bores, or the track clamping holders are constructed in at least two parts with the interposition of a plastic plate (see, for example, p. 3/06), so that they can be placed on the track with sufficient pressing force. The aforementioned plastic insert is undesirable due to its wear behavior under continuous loading. In addition, the multipart construction, especially of those track clamping holders that are run over by the track frame of the sliding door system, results in greater expense in the manufacture of the aforementioned track clamping holders and requires a high degree of precision, especially in the area of the track receiver of the track clamping holder, to guarantee play-free support of the track in the track receiver of the track clamping holder.

U.S. Pat. No. 4,905,345 describes a track guide for sliding doors with the use of a track holder. The track is supported in a U-shaped section, which is supported by an angle flange of the track holder. A locking screw that passes through the angle flange of the track holder and the web of the U-shaped section engages a coupling, which joins two track sections with each other and whose lateral surface is flush with the lateral surface of the tracks.

The primary application improves the devices described above by guiding the track clamping holder, which is designed as a single piece, in the track receiver with very little play and by providing the track clamping holder with a clamping device that adjusts the track towards the track receiver, which clamping device consists of a track clamp that changes the diameter of the track receiver. The track clamp itself is operated by means of a locking screw that fits into the track clamp, so that it clamps the track in the track receiver by eliminating the play between the track receiver and the track. The clamping between the track clamping holder and the substrate—for example, a pane of glass—is accomplished by another setscrew that clamps a connection plate of the track clamping holder with an opposing plate of the substrate.

In further development of the object of the primary application, the objective of the invention is to be able to eliminate the additional requirement of a device that clamps the connection plate of the track clamping holder with the substrate.

The invention achieves this objective with the teaching of claim 1.

In accordance with this teaching, one or more openings are provided in the wall of the track clamping holder on the side facing the substrate, in which a softer material or a spreading element is inserted, which, when acted upon, nonpositively clamps the track clamping holder with both the track and the substrate or parts attached to the substrate.

This can be achieved, for example, by a rubber-like insert that extends into the space of the track clamping holder and at the same time into the region of the clamping holder (substrate). In another embodiment, a spreading element may be used.

Accordingly, the operation of only a single spreading element is required to clamp the track in the track clamping holder and, at the same time, to clamp the track clamping holder with the substrate.

Additional features of the invention are described in the dependent claims.

In accordance with the primary application, the track clamping holder has a connection plate formed as a single piece on its side facing the substrate; in an improved refinement, it is proposed that the opening pass through the wall of the track clamping holder and the connection plate and that it be designed as an oblong hole, whose longer axis runs coaxially with the longitudinal axis of the track.

In accordance with a special modification of the invention, the formation of the opening as an oblong hole allows the aforesaid spreading element, which consists, for example, of two adjoining wedges with oppositely inclined sliding surfaces, to be inserted in the oblong hole in such a way that, when at least one of the wedges is acted upon axially, both wedges move laterally in opposite directions, so that one wedge clamps the track clamping holder with the track and one wedge clamps the track clamping holder with the substrate or parts attached to the substrate. When one of the two aforesaid wedges is acted upon, the sliding surfaces thus slide along each other, so that one of the adjoining wedges moves towards the track and the other wedge moves towards the substrate under the influence of the frictional contact of the adjoining sliding surfaces of the wedges.

The axial loading of one or both of the wedges is effected by a setscrew that passes through the wall of the track clamping holder coaxially to the longitudinal axis of the track and can be adjusted against an end face of a wedge.

To achieve friction-intensifying contact between the wedges over the largest possible area in the clamped position on the track, on the one hand, and on the substrate, on the other hand, the invention is further characterized by the fact that the surface of the wedge facing the track receiver is essentially flush with the curvature of the track receiver, and the surface of the other wedge facing the substrate is essentially flush with the surface of the connection plate facing the substrate.

It is also possible to design the spreading element as a single piece. In this case, the spreading element must be made of a material that causes the spreading element to be pushed apart when acted on by pressure.

As a result, a solution is being proposed in accordance with the invention, by which the track clamping holder can be nonpositively clamped with both the track and the substrate by the operation of only a single setscrew.

The invention is explained in greater detail below on the basis of two embodiments.

FIGS. 1 to 4 show a first embodiment.

FIG. 1 shows a view of the track clamping holder against the connection plate.

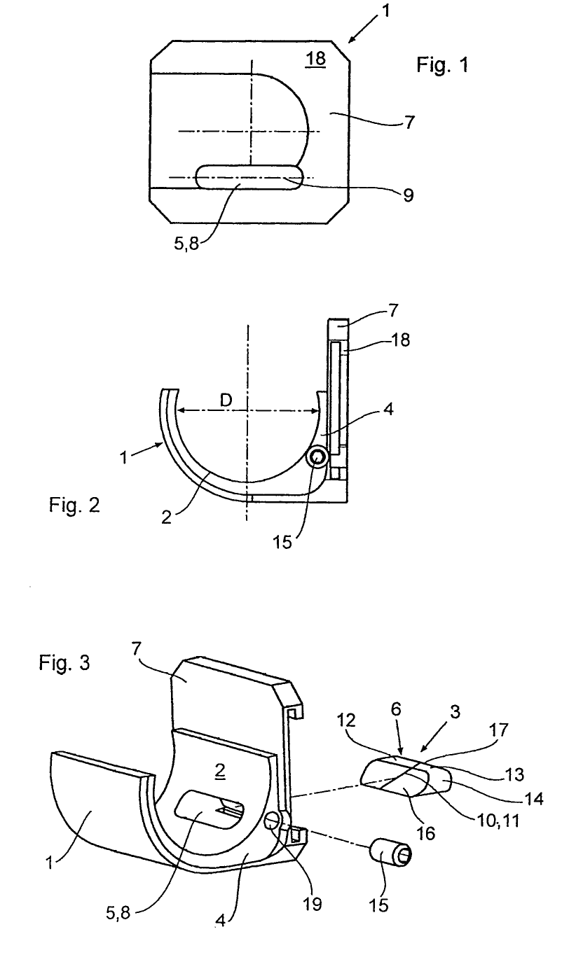

FIG. 2 shows a side view of the track clamping holder.

FIG. 3 shows a perspective view of the track clamping holder.

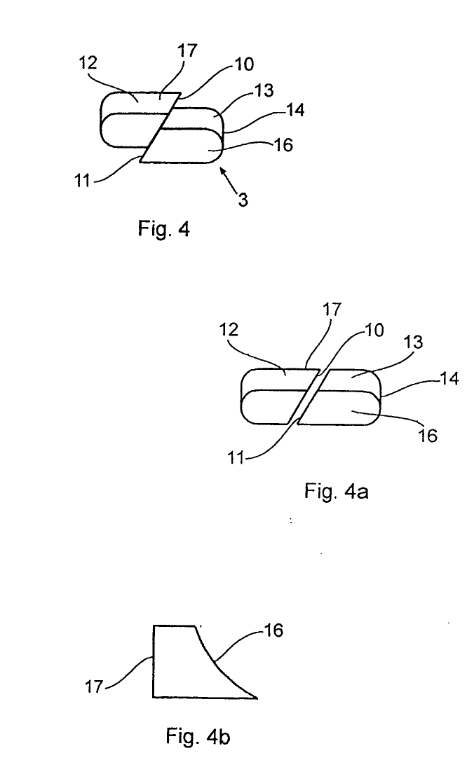

FIG. 4 shows a perspective view of the wedges of the spreading element.

FIG. 4a shows a two-piece spreading element (wedges pulled apart).

FIG. 4b shows a spreading element in a side view.

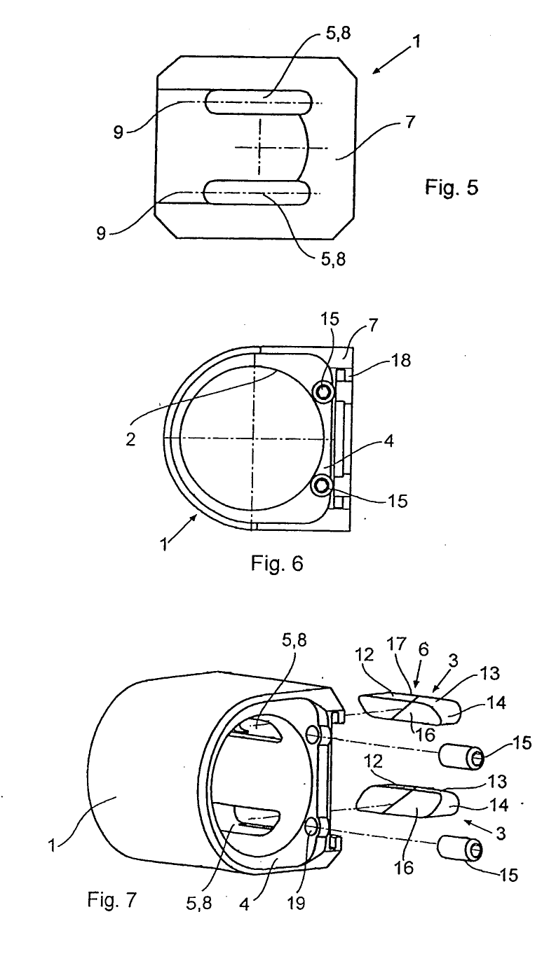

FIGS. 5 to 7 show a second embodiment.

FIG. 5 shows a view of the track clamping holder against the connection plate.

FIG. 6 shows a side view of the track clamping holder.

FIG. 7 shows a perspective view of the track clamping holder.

The track clamping holder 1 in accordance with FIGS. 1 to 4 has a track receiver 2, whose diameter is labeled D. A wall 4 of the track clamping holder 1 is provided with an opening 5, which is designed as an oblong hole 8, whose axis 9 runs coaxially with the longitudinal axis of the track, which is not shown. The clamping device 3, which can be inserted in the oblong hole 8, is formed by a spreading element 6, which consists of two wedges 12 and 13. It is clear from the drawing that the oblong hole 8 passes through both the wall 4 of the track clamping holder 1 and a connection plate 7, which is formed as a single piece on the track clamping holder 1. The adjoining surfaces of the two wedges 12 and 13 are designed as sliding surfaces 10, 11. The sliding surfaces 10, 11 run in two directions obliquely to the end face 14. In this way, with proper selection of the material of the wedges 12, 13 and of the oblique sliding surfaces 10, 11, lateral pressure causes spreading of the wedges 12, 13. In both embodiments, a setscrew 15 can be adjusted through a bore 19 against an end face 14 of the wedge 13, which is the wedge on the right in the plane of the drawing. When the setscrew 15 is operated, the sliding surfaces 10 and 11 of the wedges 12 and 13 slide along each other, so that the position shown in FIG. 4 is obtained. In the embodiment shown here, when this occurs, a surface 16 of the wedge 13 (FIG. 4b), which is designed to complement the track, is pressed against a lateral surface of the track, which is not shown, and clamps the track with the track clamping holder 1, while a surface 17 of the wedge 12 moves in the opposite direction, i.e., it emerges from the opening 5 beyond a surface 18 bounding the connection plate 7 and clamps the track clamping holder 1 with the attached construction, which is not shown.

The embodiment illustrated in FIGS. 5 to 7 differs from the embodiment illustrated in FIGS. 1 to 4 only in that two clamping devices 3 formed by the spreading elements 6 are arranged one above the other in the track clamping holder 1.

The wedges 12, 13 may consist of aluminum, plastic, rubber, or other suitable materials.

List of Reference Numbers

1 track clamping holder

2 track receiver

3 clamping device

4 wall

5 opening

6 spreading element

7 connection plate

8 oblong hole

9 axis of the oblong hole

10 sliding surface

11 sliding surface

12 wedge

13 wedge

14 end face

15 setscrew

16 surface of the wedge

17 surface of the wedge

18 surface of the connection plate

19 bore

D diameter

1-10 (cancelled)

11. A track clamping holder for mounting a track of a sliding door system on a substrate, said track clamping holder comprising:
a track receiver formed as a single piece and having a track receiving opening profiled to extend around more than half the circumference of a track, said track receiver comprising a wall bounding said receiving opening, said wall having a side facing the substrate,
at least one clamping opening in the wall on the side facing the substrate,
a clamping device received in each said clamping opening, and
means for acting on each said clamping device so that said holder can be nonpositively clamped to both the track and the substrate.

12. A track clamping holder as in claim 11 wherein said clamping device is a spreading element.

13. A track clamping holder as in claim 11 further comprising a connection plate formed integrally with the wall of the track receiving opening, each said clamping opening passing through the wall of the track receiver and the connection plate.

14. A track clamping holder as in claim 11 wherein each said clamping opening is an elongate opening having a longitudinal axis which is parallel to the axis of the track.

15. A track clamping holder as in claim 14 wherein the clamping device comprises a pair of wedges having mutually facing inclined surfaces arranged so that, when the wedges are urged together in the direction of the longitudinal axis of the clamping hole, the wedges move laterally of said axis so that one of the wedges is urged against the track and the other of the wedges is urged against the substrate.

16. A track clamping holder as in claim 15 wherein the means for acting on each said clamping device comprises a set screw that passes through the wall coaxially with the longitudinal axis of the clamping opening for urging the wedges axially together.

17. A track clamping holder as in claim 15 wherein the one of the wedges urged against the track has a surface which conforms to the track, and the other of the wedges has a surface which conforms to the substrate.

18. A track clamping holder as in claim 12 wherein the spreading element is a single piece.

19. A track clamping holder as in claim 11 wherein the clamping device is made of one of aluminum, rubber, and plastic.
